(19) United States
(12) Patent Application Publication
(10) Pub. No.: US 2020/0262505 A1
(43) Pub. Date: Aug. 20, 2020

(54) FOLDING BICYCLE HEAD TUBE

(71) Applicant: PAO-HSIEN CHENG, TAINAN (TW)

(72) Inventor: PAO-HSIEN CHENG, TAINAN (TW)

(21) Appl. No.: 16/280,193

(22) Filed: Feb. 20, 2019

(51) Int. Cl. B62K 15/00

(52) U.S. Cl. CPC B62K 15/006

(57) ABSTRACT

A folding bicycle head tube composed of an upper tube with an upper base, a lower tube with a lower base, a first locking member and a second locking member is revealed. The lower tube includes a shaft able to be mounted into the upper tube through an opening of the upper tube. The first and the second locking members are disposed on two opposite sides of the upper and lower bases at the position between the upper and lower bases respectively for locking the upper and the lower tubes in the connected state. In the second locking member, a pressing rod is pivotally connected to a guiding bar that is inserted through the upper base and the pressing rod abuts against the upper base. The head tube is folded by the first locking member unlocked and the shaft of the lower tube released from the upper tube.

### BACKGROUND OF THE INVENTION

### Field of the Invention

The present invention relates to a folding head tube, especially to a folding head tube applied to bicycles.

### Description of Related Art

For easy storage and transportation, the bicycle is usually designed to be folded into a compact size. The bicycle with the minimized volume occupies very little space during the storage. Besides folding design of other components of the frame, the head tube of the bicycle is also foldable for reducing the volume required during storage and transportation.

Generally, the head tube is formed by an upper tube and a lower tube. For easy and quick folding/unfolding of the head tube, one side of the upper tube and that of the lower tube are pivotally connected by pivot lugs while the other sides of the upper and lower tubes are connected by a fastener. The upper and lower tubes are positioned by the fastener after being extended for users to control the direction. In order to fold the head tube quickly, the upper tube is folded downward around the axis where the pivot lug on one side of the upper tube and that on one side of the lower tube are pivotally connected.

However, the pivot lug of the upper tube and the pivot lug of the lower tube pivotally connected are main components that bear the load while the head tube is in use. Thus the pivot lugs are deformed easily and the durability of the folding bicycle head tube is further affected.

Thus there is room for improvement and the there is a need to provide a novel folding bicycle head tube.

### SUMMARY OF THE INVENTION

Therefore it is primary object of the present invention to provide a folding bicycle head tube that not only allows the bicycle to have compact volume after being folded but also improves structural strength of the head tube at the position being folded. Thus the head tube is stronger and more durable.

In order to achieve the above object, a folding bicycle head tube according to the present invention includes an upper tube, a lower tube, a first locking member and a second locking member. The upper tube consists of an opening facing downward and an upper base disposed on the lower end thereof. The lower tube is composed of a lower base arranged at the upper end thereof and a shaft that is projecting from the top end thereof and able to be mounted into the upper tube through the opening for connecting the upper tube and the lower tube. The first locking member and the second locking member are disposed on two opposite sides of the upper base and the lower base at the position between the upper base and the lower base respectively for locking the upper tube and the lower tube in the connected state. The second locking member is composed of a guiding bar, an insertion ring, and a pressing rod. A lower end of the guiding bar is pivotally connected to the lower base while the insertion ring is connected to the upper base and the guiding bar is inserted through the insertion ring. The pressing rod includes an upper end thereof pivotally connected to an upper end of the guiding bar and a lower end thereof that forms a leaning portion abutting against a circular surface of the insertion ring.

The first locking member includes a locking part and a spring. The locking part consists of two side walls, a transverse segment and a threaded member screwed on the transverse segment. The transverse segment connects the two side walls so that the locking part is C-shaped while the two side walls are pivotally connected to a pivot lug of the lower base, respectively. A tip of the threaded member is projecting from the bottom surface of the transverse segment. The spring is fixed on the upper base and the tip of the threaded member is tightly pressed against the surface of the spring so that the locking part is in the locked and fixed state.

The insertion ring is further provided with a fit ring mounted therein. The fit ring is a ring with an insertion hole at the center thereof and a top surface thereof is a circular surface against which the leaning portion abuts. At least one mounting segment is extended downward from the periphery of the insertion hole of the fit ring and inserted through the insertion ring. At least one hook part is disposed on a rear end of the mounting segment and the hook part is mounted into a part of the circumference of the insertion ring so that the fit ring is fixed on the insertion ring.

The guiding bar further includes a threaded hole with an opening facing upward and located on top end thereof. A fastener is inserted through a washer to be screwed into the threaded hole. A top end of the pressing rod is pivotally connected to the washer.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view of an embodiment according to the present invention;

FIG. 2 is a partial perspective view of an embodiment according to the present invention;

FIG. 3 is a side view of an assembled embodiment according to the present invention;

FIG. 4 is a longitudinal sectional view of an embodiment according to the present invention;

FIG. 5 is a schematic drawing showing an embodiment applied to a bicycle and extended while in use according to the present invention;

FIG. 6 is a schematic drawing showing how an embodiment is folded according to the present invention;

FIG. 7 is another schematic drawing showing how an embodiment is folded according to the present invention;

FIG. 8 is a schematic drawing showing an embodiment applied to a bicycle and folded for storage according to the present invention.

### DETAILED DESCRIPTION OF THE PREFERRED EMBODIMENT

In order to learn the technical features and functions of the present invention more clearly and completely, please refer to the embodiments described below, related figures and reference characters.

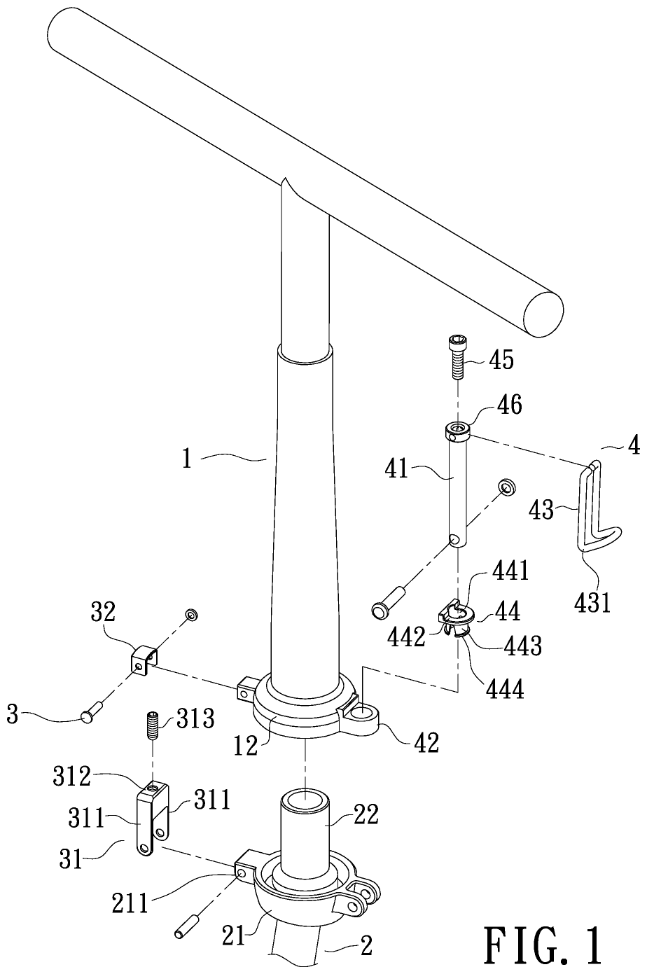

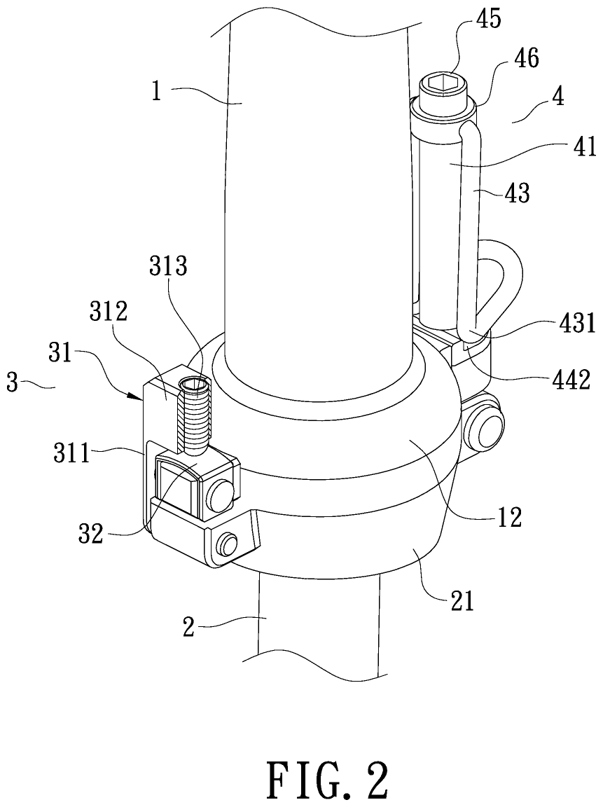

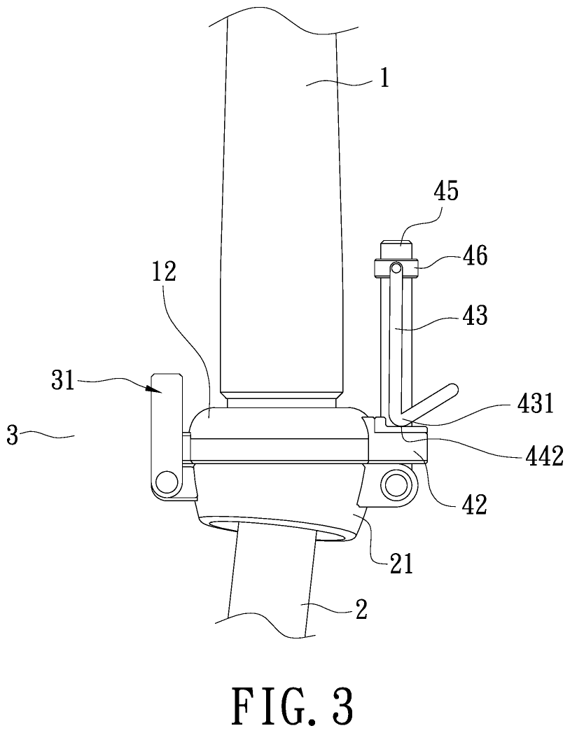

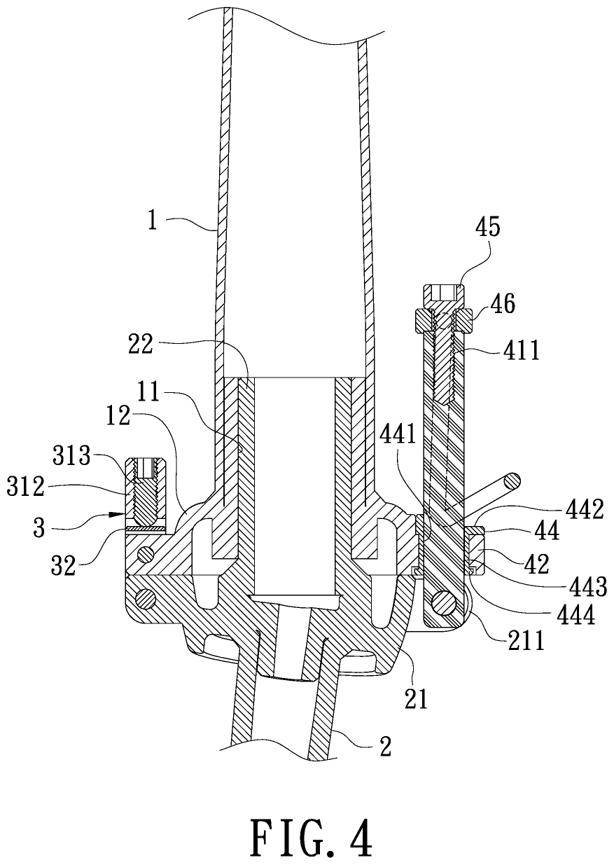

Refer to FIG. 1, FIG. 2 FIG. 3 and FIG. 4, a folding bicycle head tube according to the present invention includes an upper tube 1, a lower tube 2, a first locking member 3 and a second locking member 4.

The upper tube 1 is formed by an opening 11 facing downward and an upper base 12 arranged at the lower end thereof. The lower tube 2 consists of a lower base 21 disposed on the upper end thereof and a shaft 22 that is projecting from the top end thereof and able to be mounted into the upper tube 1 through the opening 11. The first locking member 3 is disposed on one side of the upper base 12 and the lower base 21 at the position between the upper base 12 and the lower base 21 for connecting and locking the upper tube 1 with the lower tube 2 at the side. The second locking member 4 is arranged at the other side of the upper tube 1 and the lower tube 2, opposite to the side with the first locking member 3, and located between the upper base 12 and the lower base 21 for joining and locking the upper tube 1 with the lower tube 2 at the side. The second locking member 4 is composed of a guiding bar 41, an insertion ring 42, and a pressing rod 43. A lower end of the guiding bar 41 is pivotally connected to the lower base 21 while the insertion ring 42 is connected to the upper base 12 and the guiding bar 41 is inserted through the insertion ring 42. An upper end of the pressing rod 43 is pivotally connected to an upper end of the guiding bar 41 while a leaning portion 431 is formed on a lower end of the pressing rod 43 and abutting against a circular surface of the insertion ring 42.

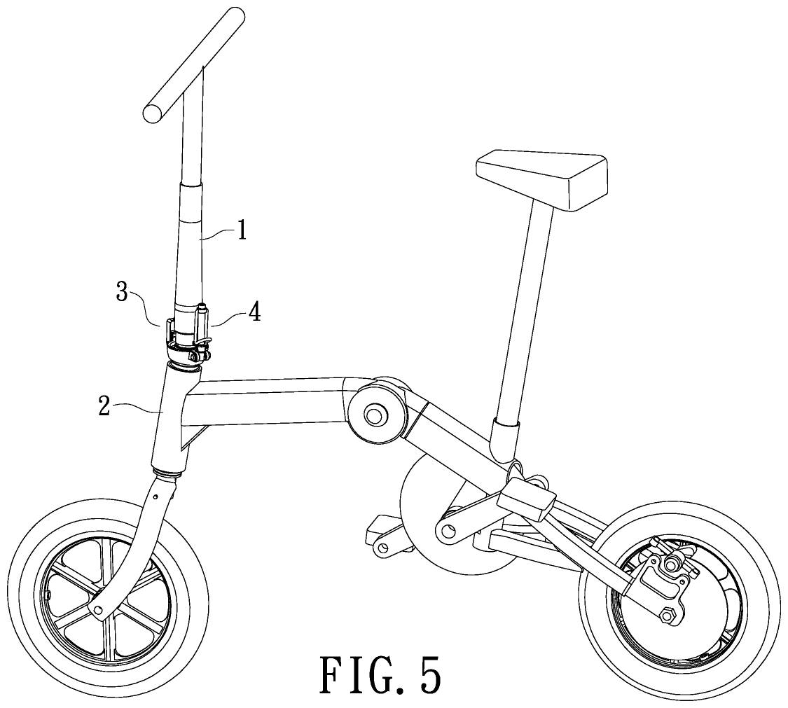

Also refer to FIG. 2, FIG. 3 FIG. 4 and FIG. 5, the second locking member 4 is locked and fastened on the other side of the upper base 12 and the lower base 21 by the leaning portion 431 on the lower end of the pressing rod 43 abutting against the circular surface of the insertion ring 42 when the shaft 22 of the lower tube 2 is mounted into the upper tube 1 through the opening 11 and the first locking member 3 is locked on one side of the upper base 12 and the lower base 21 for fastening that side of the upper base 12 and the lower base 21. Thereby the upper tube 1 and the lower tube 2 of the head tube are connected firmly. Under the state, the load on the head tube in use can be distributed to the centered upper base 12, the lower base 21, the upper tube 1 and the lower tube 2. The first locking member 3 and the second locking member 4 on two sides of the head tube respectively are not the main components that bear the load. Therefore the folding head tube of the present invention is stronger and more durable.

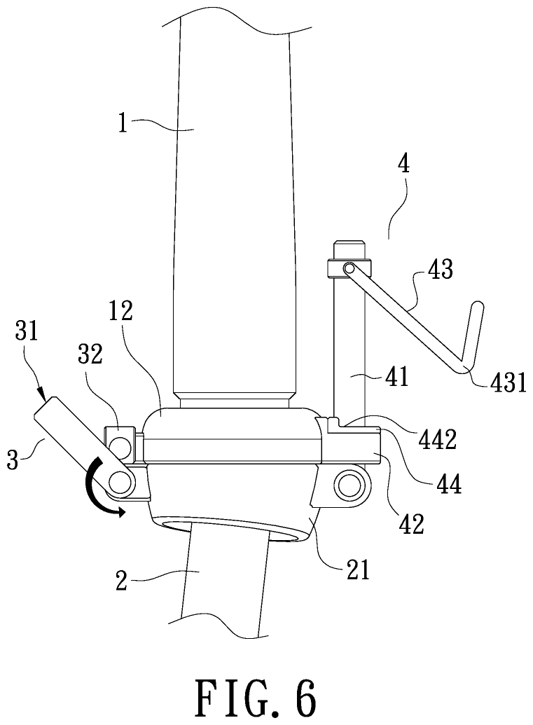

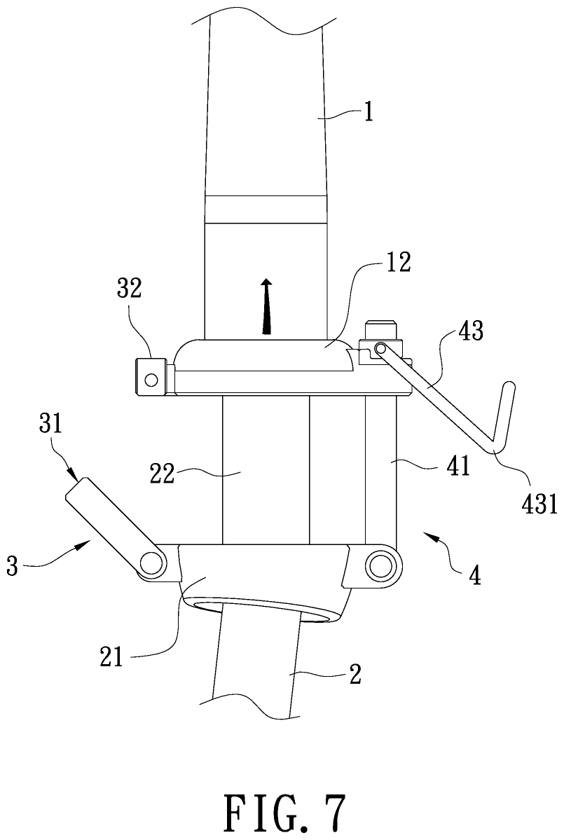

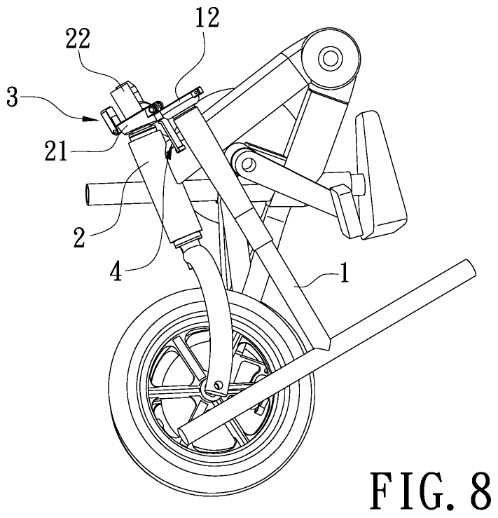

Refer to FIG. 6, FIG. 7, and FIG. 8, in order to fold the head tube, the first locking member 3 fastened on one side of the upper base 12 and one side of the lower base 21 is first released. Then the pressing rod 43 is pulled up so that the leaning portion 431 on the lower end of the pressing rod 43 is separated from the circular surface of the insertion ring 42, without abutting against the circular surface of the insertion ring 42. At the moment, users can move the upper tube 1 along the length direction of the guiding bar 41 and the shaft 22 owing to the design of the insertion ring 42 fit around the guiding bar 41 and the shaft 22 mounted in the upper tube 1. When the shaft 22 is released from upper tube 1, the upper tube 1 is folded around the axis where the guiding bar 41 and the lower base 21 are pivotally connected. Thus the folding of the head tube has been completed.

Refer to FIG. 1, FIG. 2 and FIG. 4, the first locking member 3 includes a locking part 31 and a spring 32. The locking part 31 consists of two side walls 311, a transverse segment 312 and a threaded member 313 screwed on the transverse segment 312. The transverse segment 312 is used for connecting the two side walls 311 so that the locking part 31 is C-shaped while the two side walls 311 are pivotally connected to a pivot lug 211 of the lower base 21, respectively. A tip of the threaded member 313 is projecting from the bottom surface of the transverse segment 312 while the spring 32 is fixed on the upper base 12 by the two ends thereof so that a top surface of the spring 32 is curved and elastic. When the locking part 31 is pulled up and the tip of the threaded member 313 is tightly pressed against the surface of the spring 32, the locking part 31 is locked and fixed on one side of the upper tube 1 and that side of the lower tube 2.

Refer to FIG. 1 and FIG. 4, the insertion ring 42 is further arranged with a fit ring 44 therein. The fit ring 44 is a ring with an insertion hole 441 at the center thereof and a top surface thereof is a circular surface 442 against which the leaning portion 431 of the pressing rod 43 abuts. At least one mounting segment 443 is extended downward from the periphery of the insertion hole 441 of the fit ring 44. At least one hook part 444 is disposed on a rear end of the mounting segment 443. The mounting segment 443 is inserted into the insertion ring 42 and then the hook part 444 is mounted into a part of the circumference of the insertion ring 42 so that the fit ring 44 is fixed on the insertion ring 42.

Refer to FIG. 1 and FIG. 4, the guiding bar 41 further includes a threaded hole 411 with an opening facing upward and located on top end thereof. A fastener 45 is inserted through a washer 46 to be screwed into the threaded hole 411. A top end of the pressing rod 43 is pivotally connected to the washer 46 so that the assembly and installation of the pressing rod 43 has become easier.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A folding bicycle head tube comprising:
an upper tube that includes an opening facing downward and an upper base disposed on the lower end thereof,
a lower tube having a lower base arranged at the upper end thereof, and a shaft that is projecting from the top end thereof and able to be mounted into the upper tube through the opening for connecting the upper tube and the lower tube, and
a first locking member and a second locking member that are disposed on two opposite sides of the upper base and the lower base at the position between the upper base and the lower base respectively for locking the upper tube and the lower tube in the connected state;
wherein the second locking member is composed of a guiding bar, an insertion ring, and a pressing rod; a lower end of the guiding bar is pivotally connected to the lower base while the insertion ring is connected to the upper base and the guiding bar is inserted through the insertion ring; the pressing rod includes an upper end thereof pivotally connected to an upper end of the pressing rod and a lower end thereof that forms a leaning portion abutting against a circular surface of the insertion ring.

2. The device as claimed in claim 1, wherein the first locking member includes a locking part and a spring; the locking part is composed of two side walls, a transverse segment and a threaded member screwed on the transverse segment; the transverse segment connects the two side walls so that the locking part is C-shaped while the two side walls are pivotally connected to a pivot lug of the lower base, respectively; a tip of the threaded member is projecting from the bottom surface of the transverse segment; the spring is fixed on the upper base and the tip of the threaded member is tightly pressed against the surface of the spring so that the locking part is in the locked and fixed state.

3. The device as claimed in claim 2, wherein a fit ring is mounted in the insertion ring; the fit ring is a ring with an insertion hole at the center thereof and a top surface thereof is a circular surface against which the leaning portion abuts; at least one mounting segment is extended downward from the periphery of the insertion hole of the fit ring and inserted through the insertion ring; at least one hook part is disposed on a rear end of the mounting segment and the hook part is mounted into a part of the circumference of the insertion ring so that the fit ring is fixed on the insertion ring.

4. The device as claimed in claim 3, wherein the guiding bar further includes a threaded hole having an opening facing upward and located on top end thereof; a fastener is inserted through a washer to be screwed into the threaded hole; a top end of the pressing rod is pivotally connected to the washer.

5. The device as claimed in claim 1, wherein a fit ring is mounted in the insertion ring; the fit ring is a ring with an insertion hole at the center thereof and a top surface thereof is a circular surface against which the leaning portion abuts; at least one mounting segment is extended downward from the periphery of the insertion hole of the fit ring and inserted through the insertion ring; at least one hook part is disposed on a rear end of the mounting segment and the hook part is mounted into a part of the circumference of the insertion ring so that the fit ring is fixed on the insertion ring.

6. The device as claimed in claim 5, wherein the guiding bar further includes a threaded hole having an opening facing upward and located on top end thereof; a fastener is inserted through a washer to be screwed into the threaded hole; a top end of the pressing rod is pivotally connected to the washer.

7. The device as claimed in claim 1, wherein the guiding bar further includes a threaded hole having an opening facing upward and located on top end thereof; a fastener is inserted through a washer to be screwed into the threaded hole; a top end of the pressing rod is pivotally connected to the washer.

8. The device as claimed in claim 2, wherein the guiding bar further includes a threaded hole having an opening facing upward and located on top end thereof; a fastener is inserted through a washer to be screwed into the threaded hole; a top end of the pressing rod is pivotally connected to the washer.
